(19) United States
(12) Patent Application Publication
(10) Pub. No.: US 2010/0061660 A1
(43) Pub. Date: Mar. 11, 2010

(54) DISPLAY DEVICE AND IMAGE RESIZING METHOD THEREOF

(75) Inventors: Wen-Hsiung Lin, Tu-Cheng (TW); Ching-I Lu, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/206,722

(22) Filed: Sep. 8, 2008

(51) Int. Cl. G06K 9/36

(52) U.S. Cl. 382/298

(57) ABSTRACT

A display device includes an image reading module, three processing module, and a pixel generating module. The image reading module reads pixel data of an original image and a predetermined destination image format (hereafter destination format). A first processing module calculates a horizontal shift value and a vertical shift value. A second processing module converts ratios of a length of the original image to a length of the destination format and a height of the original image to a height of the destination format to integer values. A third processing module determines which pixel in the original image to copy to each pixel position in the destination format. A pixel generating module copies pixels in the original image to corresponding pixels positions in the destination format.

### BACKGROUND

1. Field of the Invention

The invention relates to display devices, and particularly to a display device and image resizing method thereof.

2. Description of Related Art

With mobile communication devices, such as mobile phones and portable computers, becoming more popular, demand for their greater functionality and faster completion speed of tasks has increased as well. Generally, sizes of imported images are inconsistent with that of images that a mobile communication device can display, therefore, the mobile communication device needs to process the imported images to resize them for the display. Conventionally, mobile communication devices resize images through a series of calculations involving floating-point type data and multiplication.

However, the calculations are complex, thus mobile communication devices take time to process the images, particularly large images, and are significantly slow to display such images. This is inefficient and unfriendly to users.

### SUMMARY

A display device for resizing an original image according to a predetermined destination image format includes an image reading module, a first processing module, a second processing module, a third processing module, and a pixel generating module. The image reading module is used for reading pixel data of the original image and the predetermined destination image format. The first processing module is used for calculating a horizontal shift value and a vertical shift value, used for resizing the original image to the predetermined destination image format, according to the pixel data and a size of a register of the display device. The second processing module is used for converting ratios of a length of the original image to a length of the predetermined destination image format and a height of the original image to a height of the predetermined destination image format to integer values, used for resizing the original image to the predetermined destination image format, according to the pixel data, the horizontal shift value and the vertical shift value. The third processing module is used for determining which pixel in the original image to copy to each pixel position in the predetermined destination image format according to the pixel data, the horizontal shift value, the vertical shift value, and the integer values from ratios of the length of the original image to the length of the predetermined destination image format and the height of the original image to the height of the predetermined destination image format. The pixel generating module is used for copying pixels in the original image to corresponding pixel positions in the predetermined destination image format to form a destination image and storing the destination image into a memory.

Other advantages and novel features will become more apparent from the following detailed description when taken in conjunction with the accompanying drawings:

### BRIEF DESCRIPTION OF THE DRAWINGS

FIG. 1 is a schematic diagram of a display device of an exemplary embodiment of the invention; and

FIG. 2 is a flowchart of an image resizing method of another exemplary embodiment of the invention.

### DETAILED DESCRIPTION

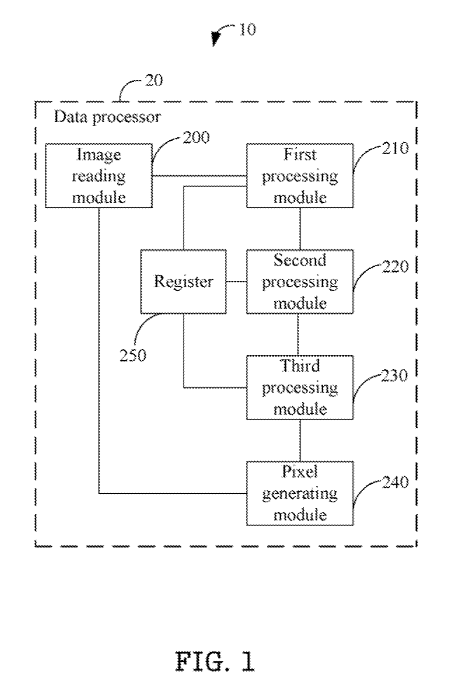

FIG. 1 is a schematic diagram of a display device 10 of an exemplary embodiment of the invention. In the exemplary embodiment, the display device 10 includes a data processor 20 for resizing an original image according to a predetermined destination image format (hereafter destination format) using a predetermined mapping algorithm, and the data processor 20 includes an image reading module 200, a first processing module 210, a second processing module 220, a third processing module 230, a pixel generating module 15, and a register 250. The register 250 is used for the calculations in the data processor 20.

The image reading module 200 is used for reading pixel data of the original image and the destination format, and for sending the pixel data to the first processing module 210. In the exemplary embodiment, the pixel data of the original image and the destination format includes lengths and heights in pixels thereof. To better describe the exemplary embodiment, a length and a height of either of the original image and the destination format corresponds to an X-axis and a Y-axis of a two dimensional coordinate system. Furthermore, x and y represent the length and height of the original image, and x′ and y′ denote the length and height of the destination format.

The first processing module 210 is connected to the image reading module 200, and is used for receiving the pixel data from the image reading module 200, and for calculating a horizontal shift value and a vertical shift value, used for resizing the original image to the destination format, according to the pixel data and a size of the register 250. In the exemplary embodiment, the horizontal shift value and the vertical shift value are used to shift a number stored in the register 250 to convert the number to an integer that represents an X or Y coordinate of a pixel to be copied from the original image. The shift values are calculated using the following formulas:

Horizontal shift value: Nₓ=A−Bₓ; and

Vertical shift value: N_{y}=A−B_{y}.

Where A is the size of the register 250 in bits, for example, in this embodiment A=32. Bₓ is how many bits are needed to represent the length of the original image in pixels, for example, an image of 2 pixels long would be 10 in binary, therefore, Bₓ=2. B_{y} is how many bits are needed to represent the height of the original image in pixels, for example, an image of 4 pixels high would be 100 in binary, therefore, B_{y}=3. According to the above examples, Nₓ=32−2=30, and N_{y}=32−3=29.

The second processing module 220 is used for converting ratios of x to x′ and y to y′ to integer values, also used for resizing the original image to the destination format, according to the pixel data, the horizontal shift value and the vertical shift value. The integer values from ratios of x to x′ and y to y′ are calculated using the following formulas:

Integer value from ratio of x to x′: dₓ=int(x/x′×2^{Nx}); and

Integer value from ratio of y to y′: d_{y}=int(y/y′×2^{Ny}).

For example, assuming that the original image is 2×4 pixels, and the destination format is 3×3 pixels, then, x=2, y=4, x′=y′=3, and according to the above example, Nₓ=30, and N_{y}=29. Thus, dₓ=int(2/3×2³⁰)=715827882, and d_{y}=int(4/3×2²⁹)=715827882.

The third processing module 230 is used for determining which pixel in the original image to copy to each pixel position in the destination format according to the pixel data, the horizontal shift value, the vertical shift value and the integer values from ratios of x to x′ and y to y′. The process begins with the first pixel of the first row of the destination format, then proceeds to each pixel in that row before going to the next row. To determine X, Y coordinates of a pixel of the original image to be copied to a current pixel position of the destination format, dₓ is first loaded into the register 250 X′ number of times, where X′ equals the X coordinate of the current pixel position. Subsequently, dₓ multiplies X′, and a resulted value is transformed into a binary value. Then the binary value in the register 250 is shifted right Nₓ bits. The binary value in the register 250 after the right shift is transformed into a decimal value, and the decimal value gives the X coordinate of the pixel to be copied. Similarly the Y coordinate is found by first loading d_{y} into the register Y′ number of times, where Y′ equals the Y coordinate of the current pixel position. Subsequently, d_{y} multiplies Y′, and a resulted value is transformed into a binary value. Then the binary value in the register 250 is shifted right N_{y} bits. The binary value in the register 250 after the right shift is transformed into a decimal value, and the decimal value remaining in the register 250 is the Y coordinate of the pixel to be copied.

In the example, the destination format is 3×3 pixels, and the original image is 2×4 pixels, so XY coordinates for pixel positions of the destination format would be (0,0), (1,0), (2,0), (0,1), (1,1), (2,1), (0,2), (1,2), (2,2). Then we use the above formulas and steps beginning with the first pixel (0,0) of the destination format, and assume that we are using a 32 bit register 250, as follows:

Nₓ=A−Bₓ=32−2=30;

N_{y}=A−B_{y}=32−3=29;

dₓ=int(x/x′×2^{Nx})=int(2/3×2³⁰)=715827882;

d_{y}=int(y/y′×2^{Ny})=int(4/3×2²⁹)=715827882.

For example, to determine the X, Y coordinates of the pixel of the original image to be copied to a position of the pixel (2, 0) of the destination image, 715827882 is first loaded into the register 250 two times. Subsequently, 715827882 multiplies 2, which resulted value is 1431655764, and the resulted value 1431655764 is transformed into a binary value 1010101010101010101010101010100. Then the binary value 1010101010101010101010101010100 in the register 250 is shifted right 30 bits, which is 0000000000000000000000000000001, and the binary value after the right shift is transformed into a decimal value 1. The decimal value 1 in the register 250 gives the X coordinate of the pixel to be copied. Similarly the Y coordinate is found by first loading d_{y} into the register 250 0 times. Subsequently, 715827882 multiples 0, which resulted value is 0, and the resulted value 0 is transformed into a binary value 0. Then the binary value 0 in the register 250 is shifted right 29 bits, and the binary value 0 after the right shift is transformed into a decimal value 0. The decimal value 0 remaining in the register 250 is the Y coordinate of the pixel to be copied. That is, the pixel (1, 0) of the original image should be copied to the position of the pixel (2, 0) of the destination format. Similarly, the third processing module 230 can determine which pixels in the original image to copy to other pixel positions in the destination format using the same steps.

The pixel generating module 240 is connected to the third processing module 230 and the image reading module 200, and is used for copying pixels in the original image to corresponding pixel positions in the destination format to form a destination image, and stores the destination image into memory.

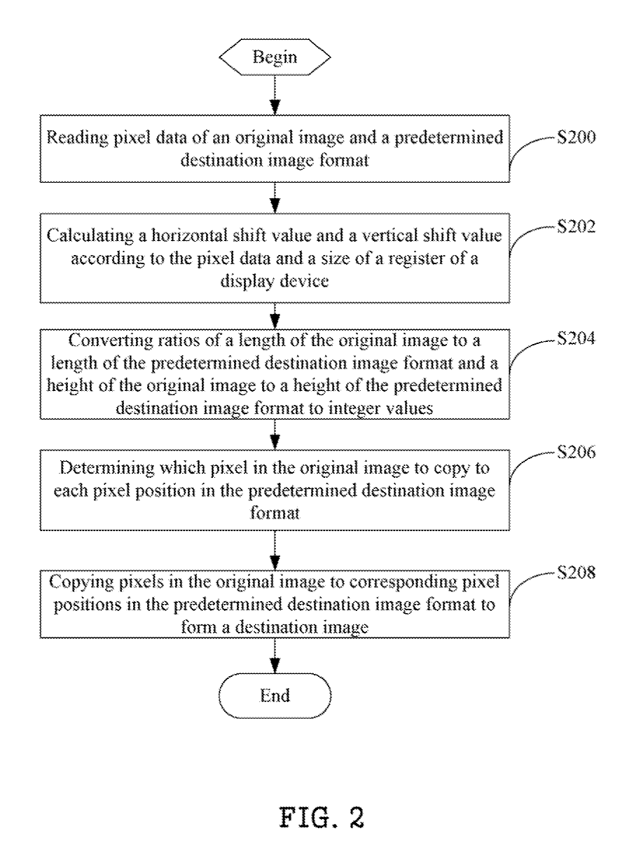

FIG. 2 is a flow chart of an image resizing method of an exemplary embodiment of the invention. In the exemplary embodiment, the image resizing method is used in the display device 10, for resizing an original image according to a predetermined destination image format (hereafter destination format) using a predetermined mapping algorithm.

In step S200, the image reading module 200 reads pixel data of the original image and the destination format, and sends the pixel data to the first processing module 210. In the exemplary embodiment, the pixel data of the original image and the destination format includes lengths and heights in pixels thereof. To better describe the exemplary embodiment, a length and a height of either of the original image and the destination format corresponds to an X-axis and a Y-axis of a two dimensional coordinate system. Furthermore, x and y represent the length and height of the original image, and x′ and y′ denote the length and height of the destination format.

In step S202, the first processing module 210 receives the pixel data, and calculates a horizontal shift value and a vertical shift value, used for resizing the original image to the destination format, according to the pixel data and a size of the register 250. In the exemplary embodiment, the horizontal shift value and the vertical shift value are used to shift a number stored in the register 250 to convert the number to an integer that represents an X or Y coordinate of a pixel to be copied from the original image. The shift values are calculated using the following formulas:

Horizontal shift value: Nₓ=A−Bₓ;

Vertical shift value: N_{y}=A−B_{y};

Where A is the size of the register 250 in bits, for example, in this embodiment A=32. Bₓ is how many bits are needed to represent the length of the original image in pixels, for example, an image of 2 pixels long would be 10 in binary, therefore Bₓ=2. B_{y} is how many bits are needed to represent the height of the original image in pixels, for example, an image of 4 pixels high would be 100 in binary, therefore B_{y}=3. According to the above examples, Nₓ=32−2=30, and N_{y}=32−3=29.

In step S204, the second processing module 220 converts ratios of x to x′ and y to y′ to integer values, used for resizing the original image to the destination format, according to the pixel data, the horizontal shift value and the vertical shift value. The integer values from ratios of x to x′ and y to y′ are calculated using the following formulas:

Integer value from ratio of x to x′: dₓint(x/x′×2^{Nx});

Integer value from ratio of y to y′: d_{y}int(y/y′×2^{Ny});

For example, assuming that the original image is 2×4 pixels, and the destination format is 3×3 pixels, then, x=2, y=4, x′=y′=3, and according to the above example, Nₓ=30, N_{y}=29. Thus, dₓ=int(2/3×2³⁰)=715827882, and d_{y}=int(4/3×22⁹)=715827882.

In step S206, for each pixel position in the destination format, the third processing module 230 determines which pixel in the original image to copy to that pixel position in the following manner according to the pixel data, the horizontal shift value, the vertical shift value and the integer values from ratios of x to x′ and y to y′. The process begins with the first pixel of the first row of the destination format, then proceeds to each pixel in that row before going to the next row. To determine X, Y coordinates of a pixel of the original image to be copied to a current pixel position of the destination format, dₓ is first loaded into the register 250 X′ number of times, where X′ equals the X coordinate of the current pixel position. Subsequently, dₓ multiplies X′, and a resulted value is transformed into a binary value. Then the binary value in the register 250 is shifted right Nₓ bits. The binary value in the register 250 after the right shift is transformed into a decimal value, and the decimal value gives the X coordinate of the pixel to be copied. Similarly the Y coordinate is found by first loading d_{y} into the register Y′ number of times, where Y′ equals the Y coordinate of the current pixel position. Subsequently, d_{y} multiplies Y′, and a resulted value is transformed into a binary value. Then the binary value in the register 250 is shifted right N_{y} bits. The binary value in the register 250 after the right shift is transformed into a decimal value, and the decimal value remaining in the register 250 is the Y coordinate of the pixel to be copied.

In the example, the destination format is 3×3 pixels, and the original image is 2×4 pixels, so XY coordinates for pixel positions of the destination format would be (0,0), (1,0), (2,0), (0,1), (1,1), (2,1), (0,2), (1,2), (2,2). Then we use the above formulas and steps beginning with the first pixel (0,0) of the destination format, and assume that we are using a 32 bit register 250, as follows:

Nₓ=A−Bₓ=32−2=30;

N_{y}=A−B_{y}=32−3=29;

dₓ=int(x/x′×2^{Nx})=int(2/3×2³⁰)=715827882;

d_{y}=int(y/y′×2^{Ny})=int(4/3×2²⁹)=715827882.

For example, to determine the X, Y coordinates of the pixel of the original image to be copied to a position of the pixel (2, 0) of the destination image, 715827882 is first loaded into the register 250 2 times. Subsequently, 715827882 multiplies 2, which resulted value is 1431655764, and the resulted value 1431655764 is transformed into a binary value 1010101010101010101010101010100. Then the binary value 1010101010101010101010101010100 in the register 250 is shifted right 30 bits, which is 0000000000000000000000000000001, and the binary value after the right shift is transformed into a decimal value 1. The decimal value 1 in the register 250 gives the X coordinate of the pixel to be copied. Similarly the Y coordinate is found by first loading d_{y} into the register 250 0 times. Subsequently, 715827882 multiples 0, which resulted value is 0, and the resulted value 0 is transformed into a binary value 0. Then the binary value 0 in the register 250 is shifted right 29 bits, and the binary value 0 is transformed into a decimal value 0. The decimal value 0 remaining in the register 250 is the Y coordinate of the pixel to be copied. That is, the pixel (1, 0) of the original image should be copied to the position of the pixel (2, 0) of the destination format. Similarly, the third processing module 230 can determine which pixels in the original image to copy to other pixel positions in the destination format using the same steps.

In step S208, the pixel generating module 240 copies pixels in the original image to corresponding pixel positions in the destination format to form a destination image, and stores the destination image into memory.

The display device 10 and the image resizing method thereof use calculations involving integer type data instead of floating-point type data, therefore calculation is simpler than before, thus, time spent on processing images is saved, and speed of processing image is increased.

The foregoing disclosure of various embodiments has been presented for purposes of illustration and description. It is not intended to be exhaustive or to limit the invention to the precise forms disclosed. Many variations and modifications of the embodiments described herein will be apparent to one of ordinary skill in the art in light of the above disclosure. The scope of the invention is to be defined only by the claims appended hereto and their equivalents.

What is claimed is:

1. A display device, for resizing an original image according to a predetermined destination image format, comprising:
a register, for calculating;
an image reading module, for reading pixel data of the original image and the predetermined destination image format;
a first processing module, for calculating a horizontal shift value and a vertical shift value, used for resizing the original image to the predetermined destination image format, according to the pixel data and a size of the register;
a second processing module, for converting ratios of a length of the original image to a length of the predetermined destination image format and a height of the original image to a height of the predetermined destination image format to integer values, used for resizing the original image to the predetermined destination image format, according to the pixel data, the horizontal shift value and the vertical shift value;
a third processing module, for determining which pixel in the original image to copy to each pixel position in the predetermined destination image format according to the pixel data, the horizontal shift value, the vertical shift value and the integer values from ratios of the length of the original image to the length of the predetermined destination image format and the height of the original image to the height of the predetermined destination image format; and
a pixel generating module, for copying pixels in the original image to corresponding pixel positions in the predetermined destination image format to form a destination image.

2. The display device of claim 1, wherein the horizontal shift value and the vertical shift value are used to shift a number stored in the register to convert the number to an integer that represents an X or Y coordinate of a pixel to be copied from the original image.

3. The display device of claim 2, wherein the horizontal shift value Nₓ and the vertical shift value N_{y} are calculated using the following formulas: Nₓ=A−Bₓ, and N_{y}=A−B_{y}, where A is the size of the register in bits, Bₓ is how many bits are needed to represent the length of the original image in pixels, and B_{y} is how many bits are needed to represent the height of the original image in pixels.

4. The display device of claim 3, wherein the integer values from ratios of the length of the original image to the length of the predetermined destination image format dₓ and the height of the original image to the height of the predetermined destination image format d_{y} are calculated using the following formulas: dₓ=int(x/x′×2^{Nx}), and d_{y}=int(y/y′×2^{Ny}), where x and y are respectively the length and the height of the original image, and x′ and y′ are respectively the length and the height of the predetermined destination image format.

5. The display device of claim 1, wherein the third processing module processes the pixels in the predetermined destination image format from the first pixel of the first row, and then processes each pixel in the first row before going to a next row.

6. The display device of claim 5, wherein to determine X, Y coordinates of a pixel of the original image to be copied to a current pixel position of the predetermined destination image format, the third processing module first loads the integer value from ratio of the length of the original image to the length of the predetermined destination image format into the register X′ number of times or the integer value from ratio of the height of the original image to the height of the predetermined destination image format into the register Y′ number of times, subsequently multiplies the integer value from ratio of the length of the original image to the length of the predetermined destination image format with X′ or the integer value from ratio of the height of the original image to the height of the predetermined destination image format with Y′, transforms a resulted value into a binary value, then shifts the binary value in the register right the horizontal shift value bits or the vertical shift value bits, transforms the binary value in the register after the right shift into a decimal value, and the decimal value give the X or Y coordinate of the pixel of the original image to be copied, where X′ and Y′ respectively equal an X coordinate and a Y coordinate of the current pixel position.

7. An image resizing method employed by a display device for resizing an original image according to a predetermined destination image format, the method comprising:
reading pixel data of the original image and the predetermined destination image format;
calculating a horizontal shift value and a vertical shift value, used for resizing the original image to the predetermined destination image format, according to the pixel data and a size of a register of the display device;
converting ratios of a length of the original image to a length of the predetermined destination image format and a height of the original image to a height of the predetermined destination image format to integer values, used for resizing the original image to the predetermined destination image format, according to the pixel data, the horizontal shift value and the vertical shift value;
determining which pixel in the original image to copy to each pixel position in the predetermined destination image format according to the pixel data, the horizontal shift value, the vertical shift value and the integer value from ratios of the length of the original image to the length of the predetermined destination image format and the height of the original image to the height of the predetermined destination image format; and
copying pixels in the original image to corresponding pixel positions in the predetermined destination image format to form a destination image.

8. The image resizing method of claim 7, wherein the horizontal shift value and the vertical shift value are used to shift a number stored in the register to convert the number to an integer that represents an X or Y coordinate of a pixel to be copied from the original image.

9. The image resizing method of claim 8, wherein the horizontal shift value Nₓ and the vertical shift value N_{y} are calculated using the following formulas: Nₓ=A−Bₓ, and N_{y}=A−B_{y}, where A is the size of the register in bits, Bₓ is how many bits are needed to represent the length of the original image in pixels, and B_{y} is how many bits are needed to represent the height of the original image in pixels.

10. The image resizing method of claim 9, wherein the integer values from ratios of the length of the original image to the length of the predetermined destination image format dₓ and the height of the original image to the height of the predetermined destination image format d_{y} are calculated using the following formulas: dₓ=int(x/x′×2^{Nx}), and d_{y}=int(y/y′×2^{Ny}), where x and y are respectively the length and the height of the original image, and x′ and y′ are respectively the length and the height of the predetermined destination image format.

11. The image resizing method of claim 10, wherein the step of determining which pixel in the original image to copy to each pixel position in the predetermined destination image format comprises steps of: processing the pixels in the predetermined destination image format from the first pixel of the first row; and
processing each pixel in the first row before going to a next row.

12. The image resizing method of claim 11, wherein the step of determining which pixel in the original image to copy to each pixel position in the predetermined destination image format further comprises steps of:
loading the integer value from ratio of the length of the original image to the length of the predetermined destination image format into the register X′ number of times or the integer value from ratio of the height of the original image to the height of the predetermined destination image format into the register Y′ number of times, where X′ and Y′ respectively equal an X coordinate and a Y coordinate of the current pixel position;
multiplying the integer value from ratio of the length of the original image to the length of the predetermined destination image format with X′ or the integer value from ratio of the height of the original image to the height of the predetermined destination image format with Y′;
transforming a resulted value of the direct step into a binary value;
shifting the binary value in the register right the horizontal shift value bits or the vertical shift value bits; and
transforming the binary value in the register after the right shift into a decimal value, and the decimal value giving the X or Y coordinate of the pixel of the original image to be copied.

13. A method employed by a display device for resizing an original image to be displayed according to a predetermined destination image format of said display device, comprising:
retrieving pixel data of said original image to be displayed and said predetermined destination image format of said display device;
converting a ratio of a length of said original image to a length of said predetermined destination image format to a first integer value;
converting a ratio of a height of said original image to a height of said predetermined destination image format to a second integer value;
resizing said original image corresponding to said predetermined destination image format by calculating for each pixel position of said predetermined destination image format based on said first and second integer values respectively; and
retrieving pixel information of said original image to be displayed at corresponding pixel positions of said predetermined destination image format to form a destination image according to a calculating result of said each pixel position of said predetermined destination image format.

14. The method of claim 13, further comprising calculating a horizontal shift value and a vertical shift value according to said pixel data and a size of a register of said display device so as to be calculated together with said first and second integer values respectively.
